(19) United States
(12) Patent Application Publication
(10) Pub. No.: US 2024/0317543 A1
(43) Pub. Date: Sep. 26, 2024

(54) PRESENTATION INFORMATION GENERATION DEVICE AND PRESENTATION INFORMATION GENERATION METHOD

(71) Applicant: Mitsubishi Electric Corporation, Tokyo (JP)

(72) Inventors: Reiko SAKATA, Tokyo (JP); Saki MATSUI, Tokyo (JP); Masami AIKAWA, Tokyo (JP); Eiji YUASA, Tokyo (JP)

(73) Assignee: Mitsubishi Electric Corporation, Tokyo (JP)

(21) Appl. No.: 18/671,093

(22) Filed: May 22, 2024

Related U.S. Application Data
(63) Continuation of application No. PCT/JP2021/046692, filed on Dec. 17, 2021.

(51) Int. Cl. B66B 3/00; B66B 5/00

(52) U.S. Cl. CPC B66B 3/002; B66B 5/0012; B66B 5/0018

(57) ABSTRACT

A presentation information generation device includes: an air flow calculating unit that acquires ventilation equipment information indicating a state of ventilation equipment in a passenger car, and outputs air flow information regarding an air flow in a car interior of the passenger car by using the ventilation equipment information; a presentation information generating unit that generates and outputs an air flow image indicating a state of the air flow in the passenger car by using the air flow information output by the air flow calculating unit; and a presentation information output unit that causes a presentation device to present the air flow image output from the presentation information generating unit.

### CROSS-REFERENCE TO RELATED APPLICATION

The present application is a continuation of International Application No. PCT/JP2021/046692, filed Dec. 17, 2021, which is incorporated herein by reference in its entirety.

### TECHNICAL FIELD

The present disclosed technique relates to a presentation information generating technique of generating information to be presented inside and outside a passenger car.

### BACKGROUND ART

There is a conventional technique of presenting information in a passenger car. For example, in a passenger car such as an elevator disposed in a building, information regarding operation, such as a floor number indicating a current position or an up and down arrow indicating a traveling direction may be presented.

By the way, Patent Literature 1 discloses a ventilation control device in a passenger car although this is not a technique of presenting information. Specifically, the ventilation control device of Patent Literature 1 variably controls a ventilation amount of a ventilation device depending on a car load of the passenger car.

### CITATION LIST

### Patent Literature

Patent Literature 1: JP H07-215603 A

### SUMMARY OF INVENTION

### Technical Problem

However, the conventional technique has a problem that a passenger cannot easily know a ventilation situation in a car interior of a passenger car.

In the first place, the ventilation control device of Patent Literature 1 only variably controls the ventilation device, and cannot solve the above problem.

The present disclosure has solved the above problem, and an object of the present disclosure is to provide a presentation information generation device that generates presentation information that allows a passenger to easily know a ventilation situation in a passenger car.

### Solution to Problem

A presentation information generation device of the present disclosure includes: air flow calculating circuitry to acquire ventilation equipment information indicating a state of ventilation equipment in a passenger car, and to output air flow information regarding an air flow in a car interior of the passenger car by using the ventilation equipment information; presentation information generating circuitry to generate and output an air flow image indicating a state of the air flow in the passenger car by using the air flow information output by the air flow calculating circuitry; and presentation information output circuitry to cause a display to present the air flow image output from the presentation information generating circuitry. The ventilation equipment is disposed in such a way as to generate a plurality of air flows including at least an air flow between a ceiling central portion and a floor central portion in the car interior of the passenger car, and the air flow calculating circuitry outputs the air flow information by further referring to an air flow information database that stores in advance a relationship between a state in the passenger car and an air flow.

### Advantageous Effects of Invention

According to the present disclosure, it is possible to provide a presentation information generation device that generates presentation information that allows a passenger to easily know a ventilation situation in a passenger car.

### BRIEF DESCRIPTION OF DRAWINGS

FIG. 1 is a diagram illustrating a presentation information generation device according to a first embodiment of the present disclosure, an information presentation system including the presentation information generation device, and peripheral devices of the information presentation system.

FIG. 2 is a diagram illustrating an example of an arrangement position of ventilation equipment according to the present disclosure.

FIG. 3 is a diagram illustrating a configuration example of a presentation device according to the present disclosure.

FIG. 4 is a flowchart illustrating an example of processing performed in the presentation information generation device according to the first embodiment.

FIG. 5 is a diagram illustrating a presentation information generation device according to a second embodiment of the present disclosure, an information presentation system including the presentation information generation device, and peripheral devices of the information presentation system.

FIG. 6 is a diagram illustrating an example of a sensor included in a sensor unit according to the present disclosure.

FIG. 7 is a flowchart illustrating an example of processing performed in the presentation information generation device according to the second embodiment.

FIG. 8 is a diagram illustrating a presentation information generation device according to a third embodiment of the present disclosure, an information presentation system including the presentation information generation device, and peripheral devices of the information presentation system.

FIG. 9 is a flowchart illustrating an example of processing performed in the presentation information generation device according to the third embodiment.

FIG. 10 is a diagram illustrating a presentation information generation device according to a fourth embodiment of the present disclosure, an information presentation system including the presentation information generation device, and peripheral devices of the information presentation system.

FIG. 11 is a flowchart illustrating an example of processing performed in the presentation information generation device according to the fourth embodiment.

FIG. 12 is a diagram illustrating a presentation information generation device according to a fifth embodiment of the present disclosure, an information presentation system including the presentation information generation device, and peripheral devices of the information presentation system.

FIG. 13 is a flowchart illustrating an example of processing performed in the presentation information generation device according to the fifth embodiment.

FIG. 14 is a diagram illustrating a presentation information generation device according to a sixth embodiment of the present disclosure, an information presentation system including the presentation information generation device, and peripheral devices of the information presentation system.

FIG. 15 is a flowchart illustrating an example of processing performed in the presentation information generation device according to the sixth embodiment.

FIG. 16 is a diagram illustrating a first presentation example using presentation information created by the presentation information generation device according to the present disclosure.

FIG. 17 is a diagram illustrating a second presentation example using the presentation information created by the presentation information generation device according to the present disclosure.

FIG. 18 is a diagram illustrating a third presentation example using the presentation information created by the presentation information generation device according to the present disclosure.

FIG. 19 is a diagram illustrating a fourth presentation example using the presentation information created by the presentation information generation device according to the present disclosure.

FIG. 20 is a diagram illustrating a fifth presentation example using the presentation information created by the presentation information generation device according to the present disclosure.

FIG. 21 is a diagram illustrating a sixth presentation example using the presentation information created by the presentation information generation device according to the present disclosure.

FIG. 22 is a diagram illustrating a seventh presentation example using the presentation information created by the presentation information generation device according to the present disclosure.

FIG. 23 is a diagram illustrating a first example of a hardware configuration for implementing a function of the presentation information generation device according to the present disclosure.

FIG. 24 is a diagram illustrating a second example of the hardware configuration for implementing the function of the presentation information generation device according to the present disclosure.

### DESCRIPTION OF EMBODIMENTS

Hereinafter, in order to describe the present disclosure in more detail, embodiments for carrying out the present disclosure will be described with reference to the attached drawings.

### First Embodiment

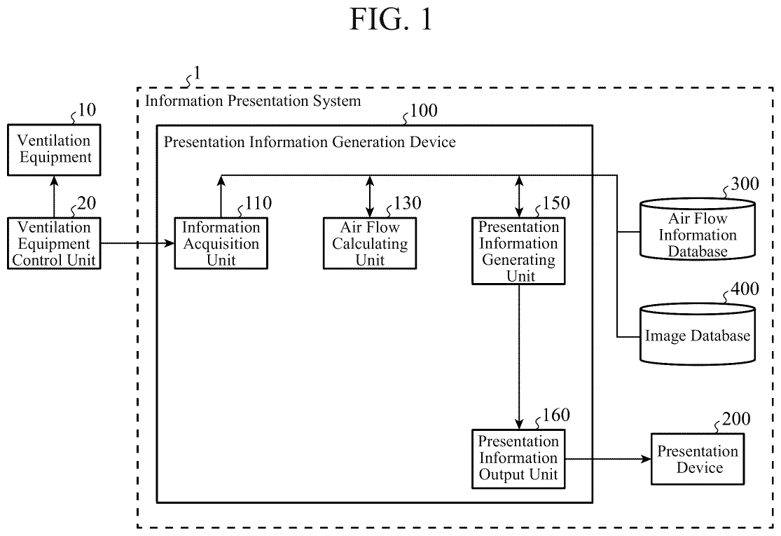

FIG. 1 is a diagram illustrating a presentation information generation device 100 according to a first embodiment of the present disclosure, an information presentation system 1 including the presentation information generation device 100, and peripheral devices of the information presentation system 1.

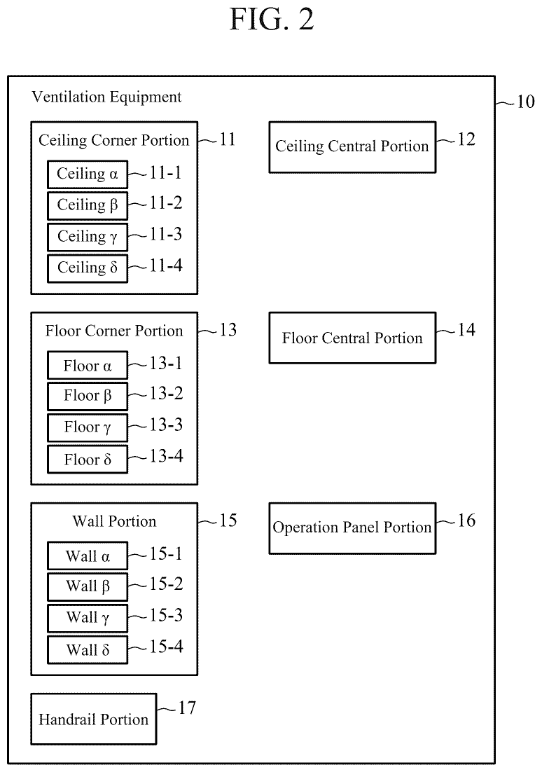

FIG. 2 is a diagram illustrating an example of an arrangement position of ventilation equipment 10 according to the present disclosure.

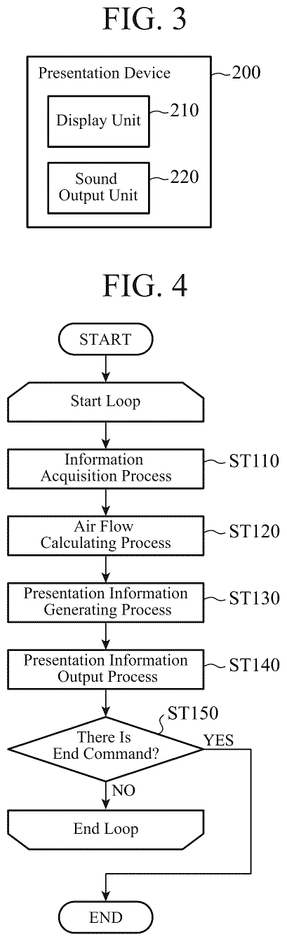

FIG. 3 is a diagram illustrating a configuration example of a presentation device 200 according to the present disclosure.

The information presentation system 1 illustrated in FIG. 1 is a system that presents information regarding a ventilation situation in a passenger car.

The information presentation system 1 is communicably connected to a ventilation equipment control unit 20 that controls the ventilation equipment 10 in the passenger car.

On, off, a flow rate, or a flow direction of the ventilation equipment 10 can be controlled.

For example, as illustrated in FIG. 2, the ventilation equipment 10 is disposed in a ceiling corner portion 11, a ceiling central portion 12, a floor corner portion 13, a floor central portion 14, a wall portion 15, an operation panel portion 16, and a handrail portion 17.

The ventilation equipment in the ceiling corner portion 11 is disposed, for example, at four places of a ceiling α 11-1, a ceiling β 11-2, a ceiling γ 11-3, and a ceiling δ 11-4. The ceiling α, the ceiling β, the ceiling γ, and the ceiling δ are, for example, four corners of a ceiling surface or four sides of the ceiling.

The ventilation equipment in the ceiling central portion 12 is disposed on the ceiling surface other than the ceiling corner portion 11, and can generate an air flow passing through the center of the car interior, for example, by cooperating with the ventilation equipment 10 disposed at a position other than the ceiling.

The ventilation equipment in the floor corner portion 13 is disposed, for example, at four places of a floor α 13-1, a floor β 13-2, a floor γ 13-3, and a floor δ 13-4. The floor α 13-1, the floor β 13-2, the floor γ 13-3, and the floor δ 13-4 are, for example, four corners of a floor surface or four sides of the floor.

The ventilation equipment in the floor central portion 14 is disposed on the floor surface other than the floor corner portion 13, and can generate an air flow passing through the center of the car interior, for example, by cooperating with the ventilation equipment 10 disposed at a position other than the floor.

The ventilation equipment in the wall portion 15 is disposed, for example, at four places of a wall α 15-1, a wall β 15-2, a wall γ 15-3, and a wall δ 15-4. For example, the wall α 15-1, the wall β 15-2, the wall γ 15-3, and the wall δ 15-4 each correspond to a corresponding one of side surfaces of the car interior.

The ventilation equipment in the operation panel portion 16 is disposed in such a way that a ventilation opening is formed in a partial area of an operation panel that receives operation by a passenger, such as designation of a destination floor or opening and closing of a door in the passenger car.

The ventilation equipment in the handrail portion 17 has a ventilation opening in a peripheral portion of a handrail when the handrail is disposed in the car interior of the passenger car. It is disposed in such a manner that the ventilation opening is not completely blocked by presence of the handrail.

In particular, by inclusion of the ventilation equipment in the ceiling central portion 12 and the ventilation equipment in the floor central portion 14, the ventilation equipment can generate a plurality of air flows including at least an air flow between the ceiling central portion 12 and the floor central portion 14 in the car interior of the passenger car.

The ventilation equipment control unit 20 controls the ventilation equipment in the passenger car.

The ventilation equipment control unit 20 can output ventilation equipment information. The ventilation equipment information is information indicating a state or an operating situation of the ventilation equipment in the passenger car, and is information including, for example, at least one of pieces of information such as on, off, a flow rate, and a flow direction.

The information presentation system 1 illustrated in FIG. 1 includes the presentation information generation device 100, an air flow information database 300, an image database 400, and the presentation device 200.

The presentation information generation device 100 acquires an air flow in the car interior by using the ventilation equipment information, and generates presentation information in which the air flow is visualized.

A configuration of the presentation information generation device 100 will be described later.

The air flow information database 300 stores in advance information indicating a state or a situation in the passenger car and air flow information in association with each other.

In the first embodiment, the information indicating a state or a situation in the passenger car is the ventilation equipment information.

The air flow information is, for example, a ventilation rate. The ventilation rate can be obtained from, for example, a ventilation amount per unit time corresponding to ventilation equipment.

The air flow information is, for example, information indicating an air flow depending on an operating state and an operating situation of the ventilation equipment. Specifically, for example, the air flow information is information indicating a vertical air flow that occurs when the ventilation equipment in the ceiling central portion and the ventilation equipment in the floor central portion are in operation.

The image database 400 stores in advance an image used when the presentation information generation device 100 generates the presentation information.

The image stored in the image database 400 is, for example, an image such as a two-dimensional image or a three-dimensional image indicating the car interior of the passenger car, an air flow image representing an air flow, or an air flow image representing an air flow with a text.

The air flow image is stored in association with the air flow information.

That is, the image database 400 stores in advance a relationship between the air flow information and the air flow image indicating a state of an air flow.

The presentation device 200 presents the presentation information generated by the presentation information generation device 100.

For example, as illustrated in FIG. 3, the presentation device 200 includes a display unit 210 and a sound output unit 220.

The display unit 210 is, for example, a display, and the sound output unit 220 is, for example, a speaker.

A configuration of the presentation information generation device 100 will be described.

The presentation information generation device 100 illustrated in FIG. 1 includes an information acquisition unit 110, an air flow calculating unit 130, a presentation information generating unit 150, and a presentation information output unit 160.

The information acquisition unit 110 acquires the ventilation equipment information.

Specifically, the information acquisition unit 110 acquires the ventilation equipment information from the ventilation equipment control unit 20, and outputs the ventilation equipment information to the air flow calculating unit 130.

The air flow calculating unit 130 acquires the ventilation equipment information, and outputs air flow information regarding an air flow at each position in the car interior of the passenger car by using the ventilation equipment information.

As described above in the description of the air flow information database 300, the positions in the car interior includes position coordinates of at least two or more points in the car interior.

As described above in the description of the air flow information database 300, the air flow information is information indicating a direction in which air flows at each position coordinate in the car interior. The air flow information may include information indicating strength of an air flow at each position coordinate in the car interior.

The air flow information is information that can be indicated in a form of a vector based on coordinates, for example.

The air flow calculating unit 130 illustrated in FIG. 1 outputs the air flow information by referring to the air flow information database 300.

Note that the air flow calculating unit 130 may output the air flow information from the ventilation equipment information with a model learned in advance by using an artificial intelligence (AI) technique.

The presentation information generating unit 150 generates and outputs an air flow image indicating a state of an air flow in the passenger car by using the air flow information output by the air flow calculating unit 130.

The presentation information generating unit 150 illustrated in FIG. 1 acquires an image by referring to the image database 400, and generates the air flow image by using the acquired image.

For example, the presentation information generating unit 150 generates an image in which an arrow image indicating an air flow or a text image is superimposed on an image of the passenger car.

The presentation information output unit 160 causes the presentation device 200 to present the air flow image output from the presentation information generating unit 150.

Processing performed in the presentation information generation device 100 according to the first embodiment will be described.

FIG. 4 is a flowchart illustrating an example of processing performed in the presentation information generation device 100 according to the first embodiment.

For example, when receiving a start command from the outside, the presentation information generation device 100 starts processing and starts loop processing.

In the loop processing, processes from step ST110 to step ST150 illustrated in FIG. 4 are repeated.

The information acquisition unit 110 executes an information acquisition process (step ST110).

Specifically, the information acquisition unit 110 acquires ventilation equipment information from the ventilation equipment control unit 20, and outputs the ventilation equipment information to the air flow calculating unit 130.

The air flow calculating unit 130 executes an air flow calculating process (step ST120).

Specifically, the air flow calculating unit 130 acquires the ventilation equipment information from the information acquisition unit 110, and outputs air flow information of each position in the car interior of the passenger car by using the acquired ventilation equipment information and referring to the air flow information database 300.

The presentation information generating unit 150 executes a presentation information generating process (step ST130).

Specifically, the presentation information generating unit 150 acquires an image by referring to the image database 400, and generates an air flow image by using the acquired image.

The presentation information generating unit 150 generates an image in which an arrow image indicating an air flow or a text image is superimposed on an image of the passenger car.

The presentation information generating unit 150 outputs presentation information including the air flow image.

The presentation information output unit 160 executes a presentation information output process (step ST140).

Specifically, the presentation information output unit 160 acquires the presentation information including the air flow image from the presentation information generating unit 150, and outputs the acquired presentation information including the air flow image to the presentation device 200.

When step ST140 is executed, subsequently, a control unit (not illustrated) in the presentation information generation device 100 checks whether there is an end command from the outside (step ST150).

If there is no end command (step ST150 “NO”), the presentation information generation device 100 repeats the processes from step ST110.

If there is an end command (step ST150 “YES”), the processing in the presentation information generation device 100 is ended.

A presentation information generation device according to the present disclosure includes: an air flow calculating unit that acquires ventilation equipment information indicating a state of ventilation equipment in a passenger car, and outputs air flow information regarding an air flow in a car interior of the passenger car by using the ventilation equipment information; a presentation information generating unit that generates and outputs an air flow image indicating a state of the air flow in the passenger car by using the air flow information output by the air flow calculating unit; and a presentation information output unit that causes a presentation device to present the air flow image output from the presentation information generating unit.

As a result, it is possible to provide a presentation information generation device that generates presentation information that allows a passenger in a passenger car to know a ventilation situation.

In the presentation information generation device according to the present disclosure, the ventilation equipment is disposed in such a way as to generate a plurality of air flows including at least an air flow between a ceiling central portion and a floor central portion in the car interior of the passenger car.

As a result, the number of candidates for the recommended position of the passenger in the passenger car can be increased from a viewpoint of ventilation.

In the presentation information generation device according to the present disclosure, the air flow calculating unit outputs the air flow information by further referring to an air flow information database that stores in advance a relationship between a state in the passenger car and an air flow.

As a result, it is possible to reduce a load of a process of calculating an air flow.

In the presentation information generation device according to the present disclosure, the presentation information generating unit generates and outputs the air flow image indicating the state of the air flow in the passenger car by further referring to an image database that stores in advance a relationship between the air flow information and an image indicating the state of the air flow.

As a result, for example, it is possible to output air flow images of various patterns by combining a plurality of images.

A presentation information generation method according to the present disclosure includes: an air flow calculating step in which an air flow calculating unit acquires ventilation equipment information indicating a state of ventilation equipment in a passenger car, and outputs air flow information regarding an air flow in a car interior of the passenger car by using the ventilation equipment information; a presentation information generating step in which a presentation information generating unit generates and outputs an air flow image indicating a state of the air flow in the passenger car by using the air flow information output by the air flow calculating unit; and a presentation information output step in which a presentation information output unit causes a presentation device to present the air flow image output from the presentation information generating unit.

As a result, it is possible to provide a presentation information generation method that generates presentation information that allows a passenger in a passenger car to know a ventilation situation.

### Second Embodiment

A second embodiment is a mode in which an air flow in a passenger car is obtained further in consideration of a passenger in the passenger car, and presentation information indicating the air flow is generated.

In description of the second embodiment, the description of the configuration already described in the first embodiment will be appropriately omitted.

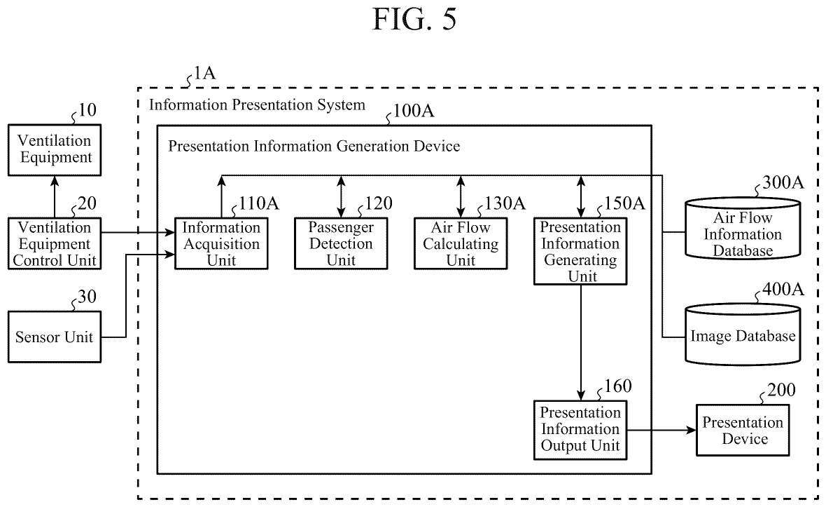

FIG. 5 is a diagram illustrating a presentation information generation device 100A according to the second embodiment of the present disclosure, an information presentation system 1A including the presentation information generation device, and peripheral devices of the information presentation system.

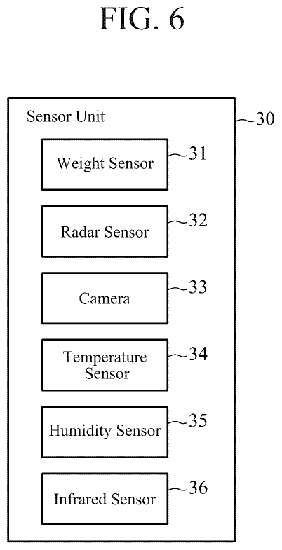

FIG. 6 is a diagram illustrating an example of a sensor included in a sensor unit 30 according to the present disclosure.

The information presentation system 1A illustrated in FIG. 5 is further communicably connected to the sensor unit 30.

As illustrated in FIG. 6, the sensor unit 30 includes a plurality of sensors such as a weight sensor, a radar sensor, a camera (monitoring camera), a temperature sensor, a humidity sensor, and an infrared sensor. The sensors constituting the sensor unit 30 are arranged at positions related to operation of a passenger car, such as in the passenger car or in a car interior.

The sensor unit 30 in the second embodiment outputs sensor data. The sensor data is, for example, a weight value of the passenger car output from a weight sensor, a distance from a radar sensor disposed in the car interior to a passenger in the car interior, or a captured image by a camera disposed in the car interior.

The information presentation system 1A illustrated in FIG. 5 includes the presentation information generation device 100A, an air flow information database 300A, an image database 400A, and a presentation device 200.

The presentation device 200 is similar to the presentation device 200 illustrated in FIG. 1, and description thereof will be omitted.

The presentation information generation device 100A acquires an air flow in the car interior by using ventilation equipment information and passenger information, and generates presentation information in which the air flow is visualized.

The passenger information is information regarding a passenger that affects an air flow in the car interior, such as a position of the passenger in the car interior, the number of passengers, and a physique of the passenger.

A configuration of the presentation information generation device 100A will be described later.

The air flow information database 300A stores in advance information indicating a state or a situation in the passenger car and air flow information in association with each other.

In the second embodiment, the information indicating a state or a situation in the passenger car includes the ventilation equipment information and the passenger information.

The air flow information is, for example, a ventilation rate. The ventilation rate can be obtained by using, for example, in addition to a ventilation amount per unit time corresponding to ventilation equipment, a time required for ventilation based on the passenger information (the number of passengers, a position of the passenger, a physique of the passenger, and the like), and an elapsed time after a door of the passenger car is closed.

The air flow information is, for example, information indicating an air flow depending on an operating state and an operating situation of the ventilation equipment. Specifically, for example, the air flow information is information indicating a vertical air flow that occurs when the ventilation equipment in the ceiling central portion and the ventilation equipment in the floor central portion are in operation.

The image database 400A is similar to the image database 400 illustrated in FIG. 1, and description thereof will be omitted here.

A configuration of the presentation information generation device 100A will be described.

The presentation information generation device 100A illustrated in FIG. 5 includes an information acquisition unit 110A, a passenger detection unit 120, an air flow calculating unit 130A, a presentation information generating unit 150A, and a presentation information output unit 160.

The information acquisition unit 110A further acquires the sensor data from the sensor unit 30.

The sensor data is, for example, a weight value of the passenger car output from a weight sensor, a distance from a radar sensor disposed in the car interior to a passenger in the car interior, or a captured image by a camera disposed in the car interior.

The passenger detection unit 120 detects a passenger in the passenger car.

Specifically, the passenger detection unit 120 acquires the sensor data from the sensor unit 30 via the information acquisition unit 110A. The passenger detection unit 120 detects a passenger in the passenger car by using the sensor data. The passenger detection unit 120 outputs passenger information indicating the detected passenger.

Similarly to the passenger information described above, the passenger information is information regarding a passenger that affects an air flow in the car interior, such as a position of the passenger in the car interior of the passenger car, the number of passengers, and a physique of the passenger.

The air flow calculating unit 130A outputs air flow information regarding an air flow in the passenger car by further using the passenger information indicating the passenger detected by the passenger detection unit 120. This is performed for obtaining an air flow in the car interior in consideration of a case where the air flow may change depending on a passenger in the passenger car (the number of passengers, a position of the passenger, a height of the passenger, and the like), which may affect ventilation.

For example, when the passenger information includes physical information, the air flow calculating unit 130A outputs air flow information regarding an air flow in the passenger car by further using the physical information.

The air flow calculating unit 130A illustrated in FIG. 5 outputs the air flow information by using the ventilation equipment information and the passenger information and referring to the air flow information database 300A.

Note that the air flow calculating unit 130A may output the air flow information by using the ventilation equipment information and the passenger information with a model learned in advance by using an AI technique.

The presentation information generating unit 150A generates an air flow image indicating a state of an air flow in the passenger car by further using the passenger information.

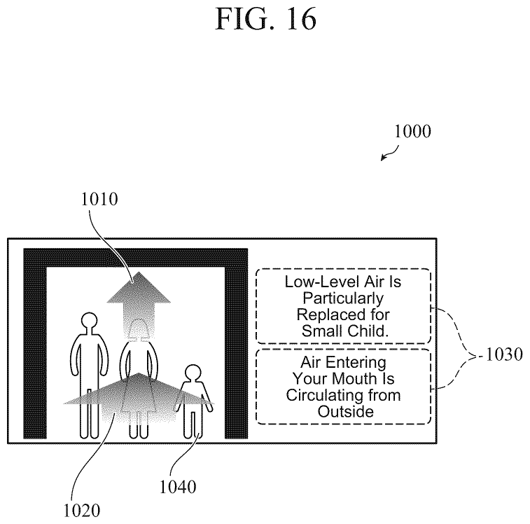

Specifically, when the passenger information includes position information indicating the position of a passenger in the passenger car, the presentation information generating unit 150A generates an air flow image (see, for example, presentation examples of presenting a passenger image in FIGS. 16, 17, and 18) indicating a state of an air flow in the passenger car together with the position of the passenger in the passenger car.

In addition, the presentation information generating unit 150A generates an air flow image (see, for example, a presentation example including a person image 1040 in FIG. 16) indicating a state of an air flow in the passenger car together with a physique of a passenger in the passenger car.

The presentation information output unit 160 is similar to the presentation information output unit 160 illustrated in FIG. 1, and description thereof will be omitted.

Processing performed in the presentation information generation device 100A according to the second embodiment will be described.

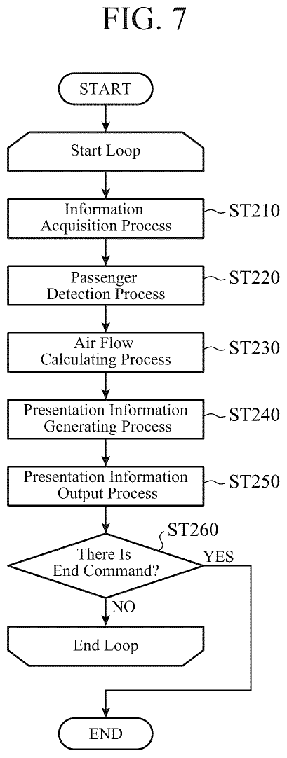

FIG. 7 is a flowchart illustrating an example of processing performed in the presentation information generation device 100A according to the second embodiment.

For example, when receiving a start command from the outside, the presentation information generation device 100A starts processing and starts loop processing.

In the loop processing, processes from step ST210 to step ST260 illustrated in FIG. 7 are repeated.

First, the information acquisition unit 110A executes an information acquisition process (step ST210).

Specifically, the information acquisition unit 110A acquires ventilation equipment information similarly to the information acquisition unit 110 of the first embodiment, and further acquires sensor data from the sensor unit 30.

Next, the passenger detection unit 120 executes a passenger detection process (step ST220).

Specifically, the passenger detection unit 120 acquires the sensor data from the sensor unit 30 via the information acquisition unit 110A. The passenger detection unit 120 detects a passenger in the passenger car by using the sensor data. The passenger detection unit 120 outputs passenger information indicating the detected passenger.

Next, the air flow calculating unit 130A executes an air flow calculating process (step ST230).

Specifically, first, the air flow calculating unit 130A acquires the ventilation equipment information and the passenger information. At this time, the air flow calculating unit 130A acquires the passenger information from the passenger detection unit 120. Next, the air flow calculating unit 130A outputs air flow information regarding an air flow in the passenger car by using the ventilation equipment information and the passenger information.

Next, the presentation information generating unit 150A executes a presentation information generating process (step ST240).

Specifically, the presentation information generating unit 150A generates presentation information including an air flow image by using the air flow information.

More specifically, first, the presentation information generating unit 150A acquires the air flow information from the air flow calculating unit 130A. Next, the presentation information generating unit 150A generates the presentation information including the air flow image by using the air flow information and referring to the image database 400A.

In addition, the presentation information generating unit 150A may generate presentation information including an air flow image indicating a state of an air flow in the passenger car by further using the passenger information.

The presentation information generating unit 150A outputs the presentation information including the air flow image.

Next, the presentation information output unit 160 executes a presentation information output process (step ST250).

Specifically, the presentation information output unit 160 acquires the presentation information including the air flow image from the presentation information generating unit 150A, and outputs the acquired presentation information including the air flow image to the presentation device 200.

Next, a control unit (not illustrated) in the presentation information generation device 100A checks whether there is an end command from the outside (step ST260).

If there is no end command (step ST260 “NO”), the presentation information generation device 100A repeats the processes from step ST210.

If there is an end command (step ST260 “YES”), the processing in the presentation information generation device 100A is ended.

The presentation information generation device according to the present disclosure includes a passenger detection unit that detects a passenger in the passenger car, and the air flow calculating unit outputs air flow information regarding an air flow in the passenger car by further using passenger information indicating the passenger detected by the passenger detection unit.

As a result, it is possible to generate presentation information indicating an air flow further in consideration of a passenger.

In the presentation information generation device according to the present disclosure, the presentation information generating unit generates an air flow image indicating a state of an air flow in the passenger car by further using the passenger information.

As a result, it is possible to further generate presentation information including an image corresponding to the passenger information.

In the presentation information generation device according to the present disclosure, the passenger information includes position information indicating a position where the passenger is in the passenger car, and the presentation information generating unit generates an air flow image indicating a state of an air flow in the passenger car together with the position of the passenger in the passenger car.

As a result, it is possible to generate presentation information including an image further indicating a position of a passenger in the passenger car.

In the presentation information generation device according to the present disclosure, the passenger information includes physique information, the air flow calculating unit outputs air flow information regarding an air flow in the passenger car by further using the physique information, and the presentation information generating unit generates an air flow image indicating a state of an air flow in the passenger car together with a physique of the passenger in the passenger car.

As a result, it is possible to generate presentation information including an image further indicating a physique of a passenger.

### Third Embodiment

A third embodiment is a mode in which an air flow in a passenger car is obtained further in consideration of operation of the passenger car, and presentation information indicating the air flow is generated.

In description of the third embodiment, the description of the configuration already described in the first or second embodiment will be appropriately omitted.

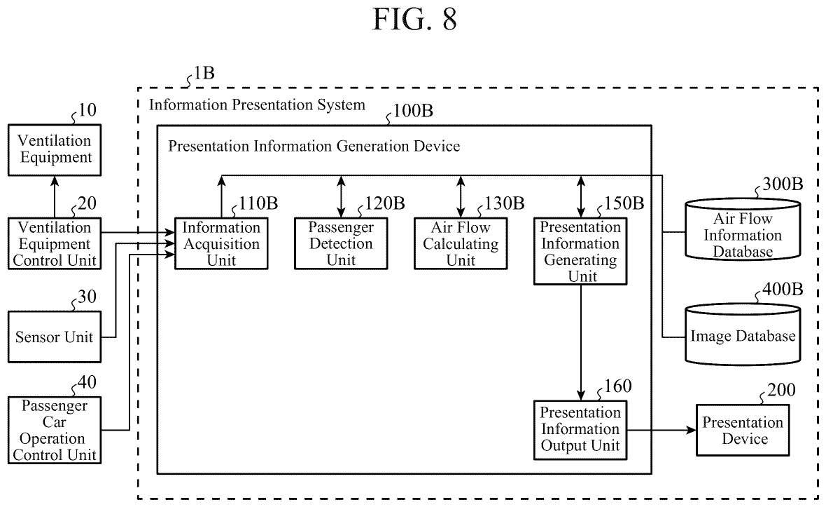

FIG. 8 is a diagram illustrating a presentation information generation device 100B according to the third embodiment of the present disclosure, an information presentation system 1B including the presentation information generation device, and peripheral devices of the information presentation system.

The information presentation system 1B illustrated in FIG. 8 is further communicably connected to a passenger car operation control unit 40.

The passenger car operation control unit 40 controls operation of the passenger car.

The passenger car operation control unit 40 outputs operation information regarding operation of the passenger car.

The operation information is an operating state or an operating situation, and is, for example, information such as a speed or a moving direction.

The information presentation system 1B illustrated in FIG. 8 includes the presentation information generation device 100B, an air flow information database 300B, an image database 400B, and a presentation device 200.

The presentation device 200 is similar to the presentation device 200 illustrated in FIG. 1, and description thereof will be omitted.

The presentation information generation device 100B acquires an air flow in the car interior by using ventilation equipment information, passenger information, and the operation information, and generates presentation information in which the air flow is visualized.

A configuration of the presentation information generation device 100B will be described later.

The air flow information database 300B stores in advance information indicating a state or a situation in the passenger car and air flow information in association with each other.

In the third embodiment, the information indicating a state or a situation in the passenger car includes the ventilation equipment information, the passenger information, and the operation information.

The air flow information is, for example, a ventilation rate. The ventilation rate can be obtained by using, for example, an operating state and an operating situation of the ventilation equipment, an operating state and an operating situation of the passenger car, and the passenger information (the number of passengers, a position of the passenger, a physique of the passenger, and the like). Specifically, first, a ventilation amount per unit time is obtained depending on an operating state and an operating situation of the ventilation equipment, and an operating state and an operating situation of the passenger car. Next, the ventilation rate can be obtained by using the ventilation amount per unit time, a time required for ventilation based on the passenger information (the number of passengers, a position of the passenger, a physique of the passenger, and the like), an elapsed time after a door of the passenger car is closed, and the like.

The air flow information is, for example, information indicating an air flow depending on an operating state and an operating situation of the ventilation equipment. Specifically, for example, the air flow information is information indicating a vertical air flow that occurs when the ventilation equipment in the ceiling central portion and the ventilation equipment in the floor central portion are in operation.

In addition, the air flow information is, for example, information indicating an air flow depending on an operating state and an operating situation of the passenger car. Specifically, the air flow information is, for example, information indicating a ventilation amount and an air flow depending on a time during which a door is open, or information indicating a ventilation amount and an air flow due to the ascent or descent.

The image database 400B is similar to the image database 400 illustrated in FIG. 1, and detailed description thereof will be omitted here.

A configuration of the presentation information generation device 100B will be described.

The presentation information generation device 100B illustrated in FIG. 8 includes an information acquisition unit 110B, a passenger detection unit 120B, an air flow calculating unit 130B, a presentation information generating unit 150B, and a presentation information output unit 160.

The information acquisition unit 110B further acquires the operation information.

Specifically, the information acquisition unit 110B acquires the operation information from the passenger car operation control unit 40.

The passenger detection unit 120B is similar to the passenger detection unit 120 illustrated in FIG. 5, and detailed description thereof will be omitted.

The air flow calculating unit 130B acquires the operation information indicating an operating situation of the passenger car or an operating state of the passenger car, and outputs air flow information regarding an air flow in the passenger car by further using the operation information. This is performed for obtaining an air flow in the car interior in consideration of a case where the air flow may change depending on movement of the passenger car, which may affect ventilation.

The air flow calculating unit 130B illustrated in FIG. 8 outputs the air flow information by using the ventilation equipment information, the passenger information, and the operation information and referring to the air flow information database 300B.

Note that the air flow calculating unit 130B may output the air flow information by using the ventilation equipment information, the passenger information, and the operation information with a model learned in advance by using an AI technique.

Similarly to the presentation information generating unit 150 of the first embodiment or the presentation information generating unit 150A of the second embodiment, the presentation information generating unit 150B generates presentation information including an air flow image.

In addition, the presentation information generating unit 150B may generate the presentation information by further using the operation information. For example, the presentation information includes an image indicating that the passenger car has been ventilated together with door opening time while the passenger car is stopped.

The presentation information output unit 160 is similar to the presentation information output unit 160 illustrated in FIG. 1, and description thereof will be omitted.

Processing performed in the presentation information generation device 100B according to the third embodiment will be described.

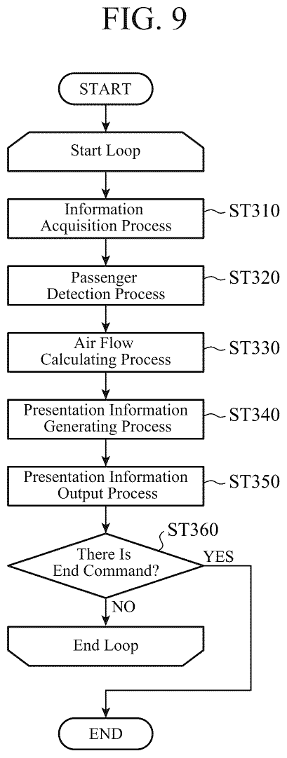

FIG. 9 is a flowchart illustrating an example of processing performed in the presentation information generation device 100B according to the third embodiment.

For example, when receiving a start command from the outside, the presentation information generation device 100B starts processing and starts loop processing.

In the loop processing, processes from step ST310 to step ST360 illustrated in FIG. 9 are repeated.

First, the information acquisition unit 110B executes an information acquisition process (step ST310).

Specifically, the information acquisition unit 110B acquires ventilation equipment information and sensor data similarly to the information acquisition unit 110A of the second embodiment, and further acquires operation information from the passenger car operation control unit 40.

Next, the passenger detection unit 120B executes a passenger detection process (step ST320).

Specifically, the passenger detection unit 120B acquires the sensor data from the sensor unit 30 via the information acquisition unit 110B. The passenger detection unit 120B detects a passenger in the passenger car by using the sensor data. The passenger detection unit 120B outputs passenger information indicating the detected passenger.

Next, the air flow calculating unit 130B executes an air flow calculating process (step ST330).

Specifically, first, the air flow calculating unit 130B acquires the ventilation equipment information, the passenger information, and the operation information. The air flow calculating unit 130B acquires the operation information from the passenger car operation control unit 40. Next, the air flow calculating unit 130B outputs air flow information regarding an air flow in the passenger car by using the ventilation equipment information, the passenger information, and the operation information.

Next, the presentation information generating unit 150B executes a presentation information generating process (step ST340).

Specifically, the presentation information generating unit 150B generates presentation information including an air flow image by using the air flow information.

More specifically, first, the presentation information generating unit 150B acquires the air flow information from the air flow calculating unit 130B. Next, the presentation information generating unit 150B generates the presentation information including the air flow image by using the air flow information and referring to the image database 400B.

In addition, the presentation information generating unit 150B may generate presentation information including an air flow image indicating a state of an air flow in the passenger car by further using the operation information.

The presentation information generating unit 150B outputs the presentation information including the air flow image.

Next, the presentation information output unit 160 executes a presentation information output process (step ST350).

Specifically, the presentation information output unit 160 acquires the presentation information including the air flow image from the presentation information generating unit 150B, and outputs the acquired presentation information including the air flow image to the presentation device 200.

Next, a control unit (not illustrated) in the presentation information generation device 100B checks whether there is an end command from the outside (step ST360).

If there is no end command (step ST360 “NO”), the presentation information generation device 100B repeats the processes from step ST310.

If there is an end command (step ST360 “YES”), the processing in the presentation information generation device 100B is ended.

In the presentation information generation device according to the present disclosure, the air flow calculating unit acquires operation information indicating an operating situation of the passenger car or an operating state of the passenger car, and outputs air flow information regarding an air flow in the passenger car by further using the operation information.

As a result, it is possible to generate presentation information including an image indicating an air flow further in consideration of operation of the passenger car.

### Fourth Embodiment

A fourth embodiment is a mode in which an air flow is obtained further using real-time sensor data.

In description of the fourth embodiment, the description of the configuration already described in the first, second, or third embodiment will be appropriately omitted.

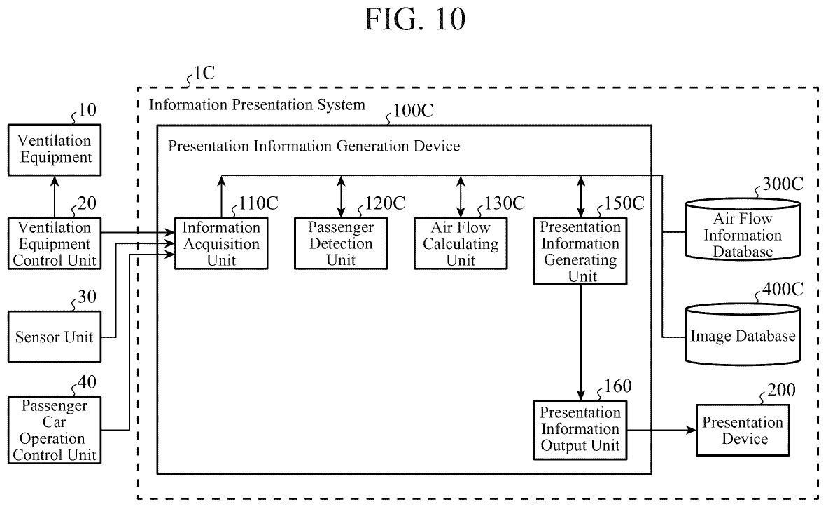

FIG. 10 is a diagram illustrating a presentation information generation device 100C according to the fourth embodiment of the present disclosure, an information presentation system 1C including the presentation information generation device, and peripheral devices of the information presentation system.

The information presentation system 1C illustrated in FIG. 10 includes the presentation information generation device 100C, an air flow information database 300C, an image database 400C, and a presentation device 200.

The presentation device 200 is similar to the presentation device 200 illustrated in FIG. 1, and description thereof will be omitted.

The presentation information generation device 100C acquires an air flow in the car interior by using ventilation equipment information, passenger information, operation information, and the sensor data, and generates presentation information in which the air flow is visualized.

The sensor data used to acquire an air flow is data indicating an air environment in the car interior, and is, for example, temperature, humidity, air quality, or the like. The air quality is, for example, a carbon dioxide concentration, a particulate substance (PM 1, PM 2.5, PM 10, etc.), or a VOC (organic compound) concentration. The air quality can be measured by using, for example, a non-dispersive infrared absorption (NDIR) type infrared sensor.

A configuration of the presentation information generation device 100C will be described later.

The air flow information database 300C stores in advance information indicating a state or a situation in the passenger car and air flow information in association with each other.

In the fourth embodiment, the information indicating a state or a situation in the passenger car includes the ventilation equipment information, the passenger information, the operation information, and the sensor data indicating an air environment.

The air flow information is, for example, a ventilation rate. The ventilation rate can be obtained by using, for example, an operating state and an operating situation of the ventilation equipment, an operating state and an operating situation of the passenger car, and the passenger information (the number of passengers, a position of the passenger, a physique of the passenger, and the like). Specifically, first, a ventilation amount per unit time is obtained depending on an operating state and an operating situation of the ventilation equipment, and an operating state and an operating situation of the passenger car. Next, the ventilation rate can be obtained by using the ventilation amount per unit time, a time required for ventilation based on the passenger information (the number of passengers, a position of the passenger, a physique of the passenger, and the like), an elapsed time after a door of the passenger car is closed, and the like.

The air flow information is, for example, information indicating an air flow depending on an operating state and an operating situation of the ventilation equipment. Specifically, for example, the air flow information is information indicating a vertical air flow that occurs when the ventilation equipment in the ceiling central portion and the ventilation equipment in the floor central portion are in operation.

In addition, the air flow information is, for example, information indicating an air flow depending on an operating state and an operating situation of the passenger car. Specifically, the air flow information is, for example, information indicating a ventilation amount and an air flow depending on a time during which a door is open, or information indicating a ventilation amount and an air flow due to the ascent or descent.

In addition, the air flow information is information indicating an air flow direction at each position in the car interior. Furthermore, the air flow information may be information including strength of the air flow at each position in the car interior. The positions in the car interior only need to include position coordinates of at least two or more points in the car interior, and may be indicated by two-dimensional coordinates or three-dimensional coordinates. In the case of the three-dimensional coordinates, it is possible for presentation information generated by the presentation information generation device 100 to three-dimensionally visualize and present an air flow in the car interior. The air flow at each position in the car interior can be obtained by using the sensor data indicating an air environment.

The image database 400C is similar to the image database 400 illustrated in FIG. 1, and description thereof will be omitted here.

A configuration of the presentation information generation device 100C will be described.

The presentation information generation device 100C illustrated in FIG. 10 includes an information acquisition unit 110C, a passenger detection unit 120C, an air flow calculating unit 130C, a presentation information generating unit 150C, and a presentation information output unit 160.

The information acquisition unit 110C further acquires the sensor data indicating an air environment in the car interior from the sensor unit 30.

The passenger detection unit 120C is similar to the passenger detection unit 120 illustrated in FIG. 5, and description thereof will be omitted here.

The air flow calculating unit 130C obtains an air flow further in consideration of an air environment in the car interior.

Specifically, the air flow calculating unit 130C acquires the sensor data indicating an air environment in the car interior of the passenger car, and outputs air flow information regarding an air flow in the passenger car by further using the sensor data.

This is performed in consideration of the fact that a ventilation rate and a three-dimensional air flow can be acquired by measuring sensor data indicating an air environment in the car interior of the passenger car or both inside and outside the car.

For example, by measuring a temperature difference between the inside and the outside of the car, it is possible to grasp a degree to which the temperature inside the car approaches the temperature outside the car, and from this, it is possible to estimate a ventilation situation (air flow).

In addition, for example, by measuring a carbon dioxide concentration, it is possible to estimate, from the number of passengers, an increase in the carbon dioxide concentration when ventilation is not performed. Then, it is possible to estimate a ventilation situation (air flow) by using a degree of decrease in the carbon dioxide concentration from the estimated value.

In addition, for example, temperature, humidity, a carbon dioxide concentration, a particulate object, a VOC concentration, and the like are measured at a plurality of places in the car. From a distribution thereof, an air flow that moves between areas can be three-dimensionally grasped on the basis of characteristics such as a characteristic of air that indicates that air flows from an area having a high concentration to an area having a low concentration and a characteristic of air that indicates that air flows from an area having a high temperature or humidity to an area having a low temperature or humidity.

The air flow calculating unit 130C illustrated in FIG. 10 outputs the air flow information by using the ventilation equipment information, the passenger information, the operation information, and the sensor data indicating an air environment and referring to the air flow information database 300C.

Note that the air flow calculating unit 130C may output the air flow information by using the ventilation equipment information, the passenger information, the operation information, and the sensor data indicating an air environment with a model learned in advance by using an AI technique.

In addition, the air flow calculating unit 130C may acquire air flow information by referring to the air flow information database 300 associating the ventilation equipment information, the passenger information, and the operation information with the air flow information. Then, the air flow calculating unit 130C may output air flow information by using the acquired air flow information and the sensor data indicating an air environment with a model learned in advance by using an AI technique.

Processing performed in the presentation information generation device 100C according to the fourth embodiment will be described.

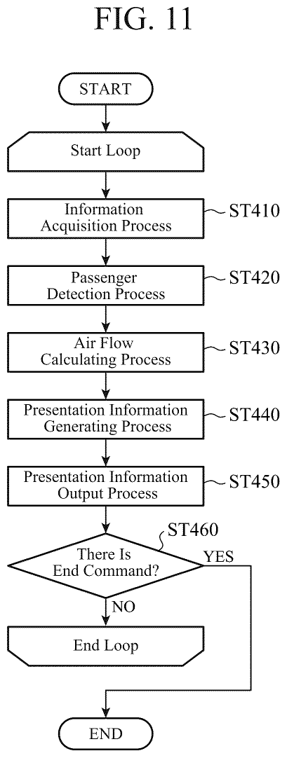

FIG. 11 is a flowchart illustrating an example of processing performed in the presentation information generation device 100C according to the fourth embodiment.

For example, when receiving a start command from the outside, the presentation information generation device 100C starts processing and starts loop processing.

In the loop processing, processes from step ST410 to step ST460 are repeated.

First, the information acquisition unit 110C executes an information acquisition process (step ST410).

Specifically, the information acquisition unit 110C acquires ventilation equipment information, sensor data for detecting a passenger, and operation information similarly to the information acquisition unit 110B of the third embodiment, and further acquires sensor data indicating an air environment from the sensor unit 30.

Next, the passenger detection unit 120C executes a passenger detection process (step ST420).

Specifically, the passenger detection unit 120C acquires the sensor data from the sensor unit 30 via the information acquisition unit 110C. The passenger detection unit 120C detects a passenger in the passenger car by using the sensor data. The passenger detection unit 120C outputs passenger information indicating the detected passenger.

Next, the air flow calculating unit 130C executes an air flow calculating process (step ST430).

Specifically, first, the air flow calculating unit 130C acquires the ventilation equipment information, the passenger information, the operation information, and the sensor data indicating an air environment. The air flow calculating unit 130C acquires the sensor data from the sensor unit 30. Next, the air flow calculating unit 130C outputs air flow information regarding an air flow in the passenger car by using the ventilation equipment information, the passenger information, the operation information, and the sensor data indicating an air environment.

Next, the presentation information generating unit 150C executes a presentation information generating process (step ST440).

Specifically, the presentation information generating unit 150C generates presentation information including an air flow image by using the air flow information.

More specifically, first, the presentation information generating unit 150C acquires the air flow information from the air flow calculating unit 130C. Next, the presentation information generating unit 150C generates the presentation information including the air flow image by using the air flow information and referring to the image database 400C.

In addition, the presentation information generating unit 150C may generate presentation information including an air flow image indicating a state of an air flow in the passenger car by further using the operation information.

The presentation information generating unit 150C outputs the presentation information including the air flow image.

Next, the presentation information output unit 160 executes a presentation information output process (step ST450).

Specifically, the presentation information output unit 160 acquires the presentation information including the air flow image from the presentation information generating unit 150C, and outputs the acquired presentation information including the air flow image to the presentation device 200.

Next, a control unit (not illustrated) in the presentation information generation device 100C checks whether there is an end command from the outside (step ST460).

If there is no end command (step ST460 “NO”), the presentation information generation device 100C repeats the processes from step ST410.

If there is an end command (step ST460 “YES”), the processing in the presentation information generation device 100C is ended.

In the presentation information generation device according to the present disclosure, the air flow calculating unit acquires sensor data indicating an air environment in the car interior of the passenger car, and outputs air flow information regarding an air flow in the passenger car by further using the sensor data.

As a result, it is possible to present an image indicating an air flow close to an air flow that changes in real time by further using an air environment in the car interior of the passenger car.

### Fifth Embodiment

A fifth embodiment is a mode in which ventilation equipment is controlled by using an air flow.

In description of the fifth embodiment, the description of the configuration already described in the first, second, third, or fourth embodiment will be appropriately omitted.

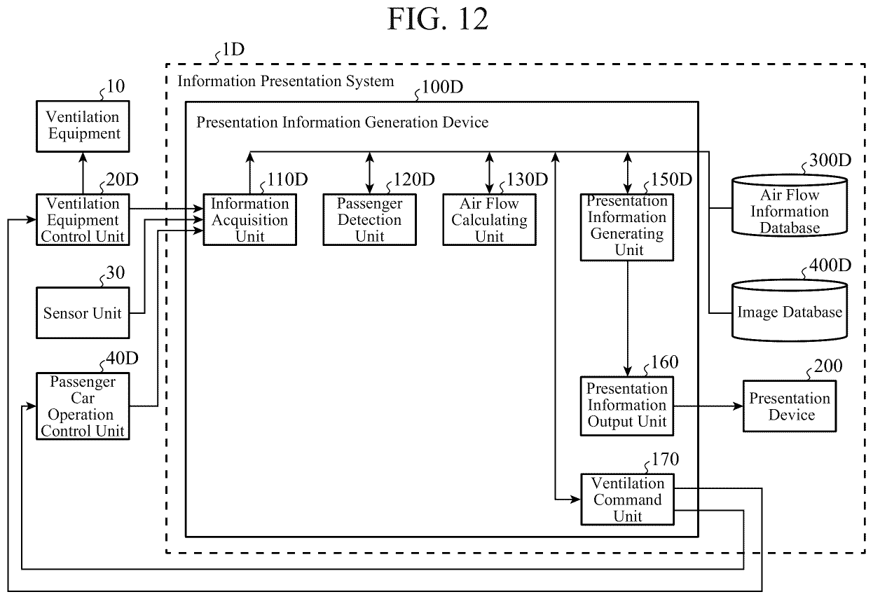

FIG. 12 is a diagram illustrating a presentation information generation device 100D according to the fifth embodiment of the present disclosure, an information presentation system 1D including the presentation information generation device, and peripheral devices of the information presentation system.

The information presentation system 1D illustrated in FIG. 12 includes the presentation information generation device 100D, an air flow information database 300D, an image database 400D, and a presentation device 200.

The air flow information database 300D is similar to the air flow information database 300C illustrated in FIG. 10, and detailed description thereof will be omitted here.

The image database 400D is similar to the image database 400C illustrated in FIG. 10, and detailed description thereof will be omitted here.

The presentation device 200 is similar to the presentation device 200 illustrated in FIG. 1, and description thereof will be omitted.

A configuration of the presentation information generation device 100D will be described.

The presentation information generation device 100D illustrated in FIG. 12 includes an information acquisition unit 110D, a passenger detection unit 120D, an air flow calculating unit 130D, a presentation information generating unit 150D, a presentation information output unit 160, and a ventilation command unit 170.

The presentation information generation device 100D newly includes the ventilation command unit 170.

The information acquisition unit 110D is similar to the information acquisition unit 110C illustrated in FIG. 10, and detailed description thereof will be omitted here.

The passenger detection unit 120D is similar to the passenger detection unit 120C illustrated in FIG. 10, and detailed description thereof will be omitted here.

The air flow calculating unit 130D is similar to the air flow calculating unit 130C illustrated in FIG. 10, and detailed description thereof will be omitted here.

The presentation information output unit 160 is similar to the presentation information output unit 160 in the other embodiments, and detailed description thereof will be omitted here.

The ventilation command unit 170 commands the ventilation equipment 20D to perform ventilation on the basis of the passenger information or the air flow information.

In addition, the ventilation command unit 170 issues a command indicating a door opening time of the passenger car on the basis of the passenger information and the air flow information. This enables ventilation in a short time in the car interior of the passenger car.

The presentation information generating unit 150D generates presentation information similarly to the presentation information generating unit 150C illustrated in FIG. 10.

In addition, the presentation information generating unit 150D may generate an air flow image including the time indicated in the command issued by the ventilation command unit 170. As a result, for example, it is possible to achieve a mode in which a door opening time of the passenger car when the passenger car stops is presented together with the fact that this is for the purpose of ventilation.

Processing performed in the presentation information generation device 100D according to the fifth embodiment will be described.

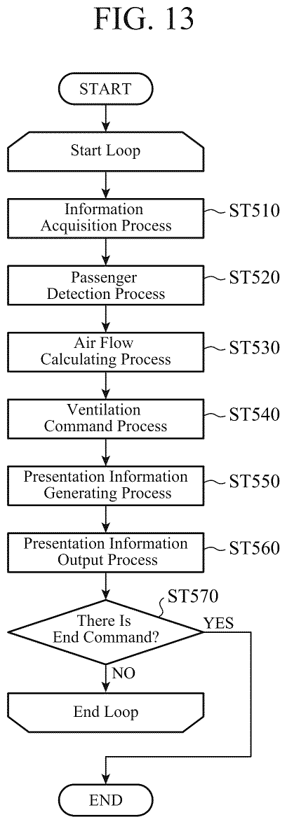

FIG. 13 is a flowchart illustrating an example of processing performed in the presentation information generation device 100D according to the fifth embodiment.

For example, when receiving a start command from the outside, the presentation information generation device 100D starts processing and starts loop processing.

In the loop processing, processes from step ST510 to step ST570 are repeated.

First, the information acquisition unit 110D executes an information acquisition process as in the fourth embodiment (step ST510).

Next, the passenger detection unit 120D executes a passenger detection process as in the fourth embodiment (step ST520).

Next, the air flow calculating unit 130D executes an air flow calculating process as in the fourth embodiment (step ST530).

Next, the ventilation command unit 170 executes a ventilation command process (step ST540).

The ventilation command unit 170 issues a command to perform ventilation on the basis of the passenger information and the air flow information.

Specifically, the ventilation command unit 170 commands the ventilation equipment 20D to perform ventilation using the passenger information and the air flow information. In this case, first, the ventilation command unit 170 acquires the passenger information and the air flow information. Next, the ventilation command unit 170 calculates a remaining space, a position of a face of a passenger, an orientation of the face of the passenger, and the like by using the passenger information. Next, the ventilation command unit 170 calculates an air flow to be generated on the basis of the remaining space, the position of the face of the passenger, the orientation of the face of the passenger, and the like, and the air flow information. Next, the ventilation command unit 170 determines a piece of ventilation equipment that generates the calculated air flow. Next, the ventilation command unit 170 commands the determined piece of ventilation equipment 20D to perform ventilation.

In addition, the ventilation command unit 170 issues a command indicating a door opening time of the passenger car on the basis of the passenger information and the air flow information. In this case, for example, when a ventilation rate is lower than a threshold, the ventilation command unit 170 further determines a door opening time of the passenger car when the door is opened next time. Next, the ventilation command unit 170 issues a command indicating the door opening time to a passenger car operation control unit 40D.

Next, the presentation information generating unit 150D executes a presentation information generating process (step ST550).

When executing the presentation information generating process, the presentation information generating unit 150D generates an air flow image including the time indicated in the command issued by the ventilation command unit 170, adds the air flow image to the presentation information, and outputs the presentation information to the presentation information output unit 160.

Next, the presentation information output unit 160 executes a presentation information output process as in the fourth embodiment (step ST560).

Next, a control unit (not illustrated) in the presentation information generation device 100D checks whether there is an end command from the outside (step ST570).

If there is no end command (step ST570 “NO”), the presentation information generation device 100D repeats the processes from step ST510.

If there is an end command (step ST570 “YES”), the processing in the presentation information generation device 100D is ended.

The presentation information generation device according to the present disclosure includes a ventilation command unit that commands the ventilation equipment to perform ventilation on the basis of the passenger information or the air flow information.

As a result, it is possible to provide a presentation information generation device that causes ventilation equipment to perform ventilation further in consideration of an air flow in the passenger car.

In the presentation information generation device according to the present disclosure, the ventilation command unit issues a command indicating a door opening time of the passenger car on the basis of the passenger information or the air flow information, and the presentation information generating unit outputs an air flow image including the time indicated in the command issued by the ventilation command unit.

As a result, it is further possible to perform ventilation while a door of the passenger car is opened.

### Sixth Embodiment

A sixth embodiment is a mode in which an image obtained by superimposing an air flow image on an actual captured image can be further presented.

In description of the sixth embodiment, the description of the configuration described in the first, second, third, fourth, or fifth embodiment will be appropriately omitted.

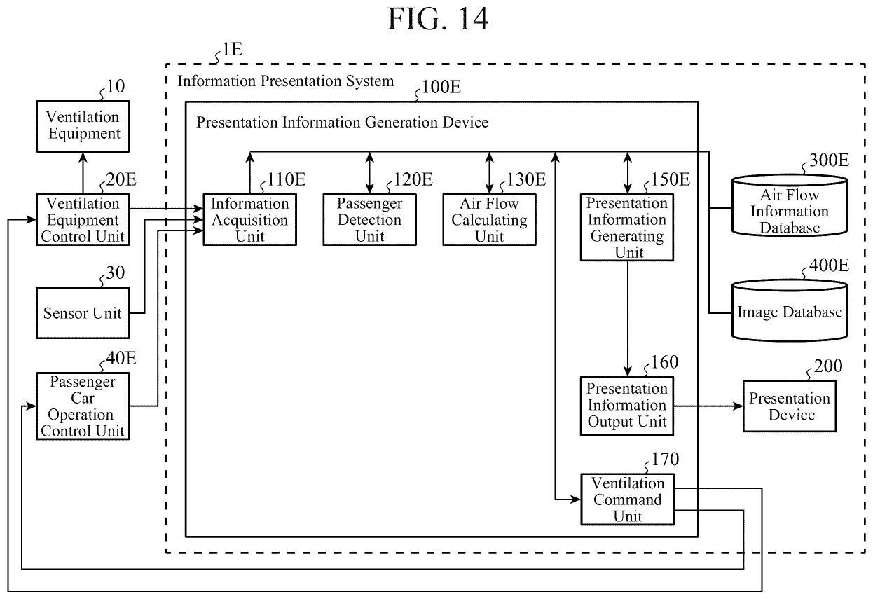

FIG. 14 is a diagram illustrating a presentation information generation device 100E according to the sixth embodiment of the present disclosure, an information presentation system 1E including the presentation information generation device, and peripheral devices of the information presentation system.

The information presentation system 1E illustrated in FIG. 14 includes the presentation information generation device 100E, an air flow information database 300E, an image database 400E, and a presentation device 200.

The air flow information database 300E is similar to the air flow information database 300D illustrated in FIG. 12, and detailed description thereof will be omitted here.

The image database 400E is similar to the image database 400D illustrated in FIG. 12, and detailed description thereof will be omitted here.

The presentation device 200 is similar to the presentation device 200 illustrated in FIG. 1, and description thereof will be omitted.

A configuration of the presentation information generation device 100E will be described.

The presentation information generation device 100E illustrated in FIG. 14 includes an information acquisition unit 110E, a passenger detection unit 120E, an air flow calculating unit 130E, a presentation information generating unit 150E, a presentation information output unit 160, and a ventilation command unit 170.

The information acquisition unit 110E is similar to the information acquisition unit 110D illustrated in FIG. 12, and detailed description thereof will be omitted here.

The passenger detection unit 120E is similar to the passenger detection unit 120D illustrated in FIG. 12, and detailed description thereof will be omitted here.

The air flow calculating unit 130E is similar to the air flow calculating unit 130D illustrated in FIG. 12, and detailed description thereof will be omitted here.

The presentation information output unit 160 is similar to the presentation information output unit 160 in the other embodiments, and detailed description thereof will be omitted here.

The ventilation command unit 170 is similar to the ventilation command unit 170 illustrated in FIG. 12, and detailed description thereof will be omitted here.

The presentation information generating unit 150E acquires a captured image obtained by imaging the car interior of the passenger car, superimposes an air flow image indicating a state of an air flow in the passenger car on the captured image, and outputs the resultant superimposed image.

More specifically, first, the presentation information generating unit 150E acquires the captured image together with air flow information. Next, the presentation information generating unit 150E generates the air flow image by using the air flow information and referring to the image database 400E. Next, the presentation information generating unit 150E generates presentation information including an image in which the air flow image is superimposed on the captured image.

Processing performed in the presentation information generation device 100E according to the sixth embodiment will be described.

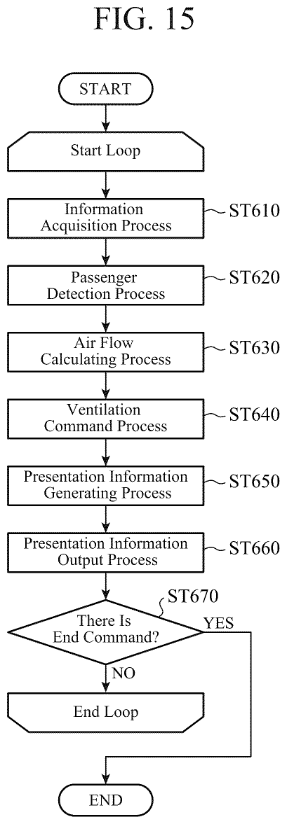

FIG. 15 is a flowchart illustrating an example of processing performed in the presentation information generation device 100E according to the sixth embodiment.

For example, when receiving a start command from the outside, the presentation information generation device 100E starts processing and starts loop processing.

In the loop processing, processes from step ST610 to step ST670 are repeated.

First, the information acquisition unit 110E executes an information acquisition process similarly to the information acquisition process in the fifth embodiment (step ST610).

Next, the passenger detection unit 120E executes a passenger detection process similarly to the passenger detection process in the fifth embodiment (step ST620).

Next, the air flow calculating unit 130E executes an air flow calculating process similarly to the air flow calculating process in the fifth embodiment (step ST630).

Next, the ventilation command unit 170 executes a ventilation command process similarly to the ventilation command process in the fifth embodiment (step ST640).

Next, the presentation information generating unit 150E executes a presentation information generating process (step ST650).

Specifically, the presentation information generating unit 150E generates presentation information including an air flow image by using air flow information.

More specifically, first, the presentation information generating unit 150E acquires the air flow information from the air flow calculating unit 130E. Next, the presentation information generating unit 150E generates the air flow image by using the air flow information and referring to the image database 400E. Next, the presentation information generating unit 150E acquires a captured image from a camera in the sensor unit 30. Next, the presentation information generating unit 150E generates an image in which the air flow image is superimposed on the captured image. Next, the presentation information generating unit 150E outputs the presentation information including the image in which the air flow image is superimposed on the captured image.

Next, the presentation information output unit 160 executes a presentation information output process (step ST660).

Next, a control unit (not illustrated) in the presentation information generation device 100E checks whether there is an end command from the outside (step ST670).

If there is no end command (step ST670 “NO”), the presentation information generation device 100E repeats the processes from step ST610.

If there is an end command (step ST670 “YES”), the processing in the presentation information generation device 100E is ended.

In the presentation information generation device according to the present disclosure, the presentation information generating unit acquires a captured image obtained by imaging the car interior of the passenger car, superimposes an air flow image indicating a state of an air flow in the passenger car on the captured image, and outputs the resultant superimposed image.

As a result, it is possible to generate presentation information that makes it easier to recognize an actual air flow in the car interior of the passenger car.

Here, a presentation example using presentation information created by the presentation information generation device 100 according to the present disclosure will be described.

FIG. 16 is a diagram illustrating a first presentation example using the presentation information created by the presentation information generation device 100 according to the present disclosure.

A presentation image 1000 is an image visualized using the presentation information, and is an image presented on the presentation device 200.

The presentation image 1000 includes an arrow image 1010, an arrow image 1020, a message image 1030, and a person image 1040.

The arrow image 1010 and the arrow image 1020 are images for visualizing an air flow. The arrow image 1020 drawn at a low position in the car interior is drawn thicker than the arrow image 1010 drawn at a high position in the car interior. This presents that a low position in the car interior is particularly ventilated.

The message image 1030 is, for example, presentation information generated using passenger information (a physique of a passenger) and air flow information, such as “Low-level air is particularly replaced for a small child”.

In addition, the message image 1030 indicates, for example, a message such as “Air entering your mouth is circulating from the outside”, and is generated using the air flow information.

The person image 1040 is presentation information generated using the passenger information (a physique of a passenger).

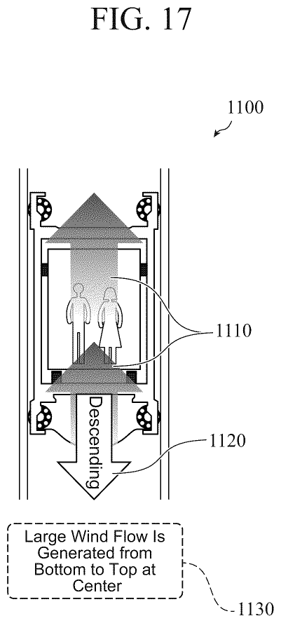

FIG. 17 is a diagram illustrating a second presentation example using the presentation information created by the presentation information generation device 100 according to the present disclosure.

A presentation image 1100 is an image presented on the presentation device 200 by using the presentation information.

The presentation image 1100 includes an arrow image 1110, an arrow image 1120, and a message image 1130.

The arrow image 1110 is an image obtained by visualizing air flow information.

The arrow image 1120 is an image including characters “descending”, and is an image generated from operation information.

The message image 1130 is, for example, an image based on the air flow information, such as “A large wind flow is generated from bottom to top at the center”.

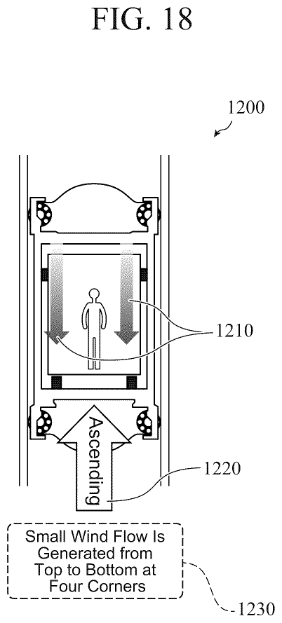

FIG. 18 is a diagram illustrating a third presentation example using the presentation information created by the presentation information generation device 100 according to the present disclosure.

A presentation image 1200 is an image presented on the presentation device 200 by using the presentation information.

The presentation image 1200 includes an arrow image 1210, an arrow image 1220, and a message image 1230.

The arrow image 1210 is an image obtained by visualizing air flow information.

The arrow image 1220 is an image including characters “ascending”, and is an image generated from operation information.

The message image 1230 is, for example, an image based on the air flow information, such as “A small wind flow is generated from top to bottom at the four corners”.

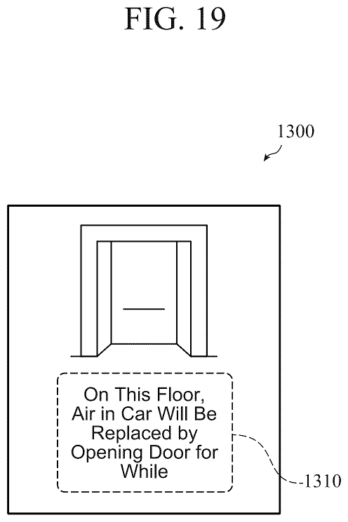

FIG. 19 is a diagram illustrating a fourth presentation example using the presentation information created by the presentation information generation device 100 according to the present disclosure.

A presentation image 1300 is an image presented on the presentation device 200 by using the presentation information.

A message image 1310 is, for example, an image based on operation information and air flow information, such as “On this floor, air in the car will be replaced by opening the door for a while”.

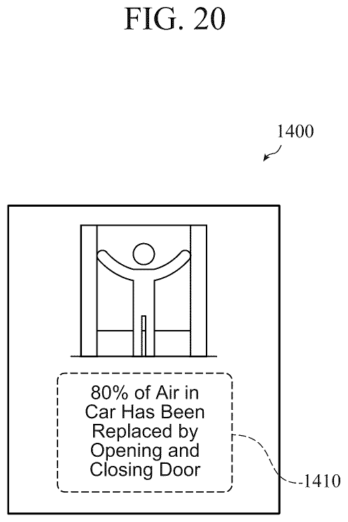

FIG. 20 is a diagram illustrating a fifth presentation example using the presentation information created by the presentation information generation device 100 according to the present disclosure.

A presentation image 1400 is an image presented on the presentation device 200 by using the presentation information.

A message image 1410 is, for example, an image based on air flow information or sensor data indicating an air environment, such as “80% of air in the car has been replaced by opening and closing the door”.

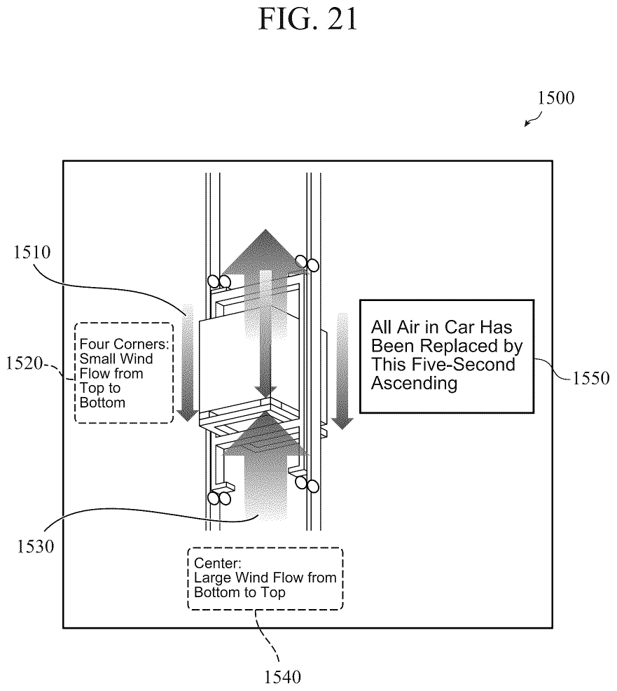

FIG. 21 is a diagram illustrating a sixth presentation example using the presentation information created by the presentation information generation device 100 according to the present disclosure.

A presentation image 1500 is an image presented on the presentation device 200 by using the presentation information.

The presentation image 1500 includes an arrow image 1510, a message image 1520, an arrow image 1530, a message image 1540, and a message image 1550.

The arrow image 1510 is an image based on air flow information.

The message image 1520 is, for example, an image based on the air flow information, such as “four corners: small wind flow from top to bottom”.

The arrow image 1530 is an image based on the air flow information.

The message image 1540 is, for example, an image based on the air flow information, such as “center: large wind flow from bottom to top”.

The message image 1550 is, for example, an image based on the air flow information and operation information, such as “All air in the car has been replaced by this five-second ascending”.

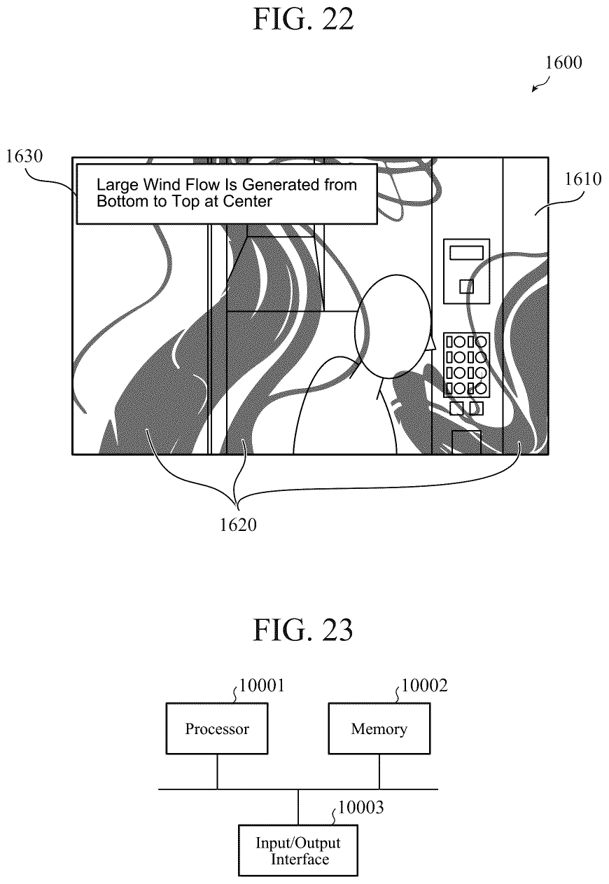

FIG. 22 is a diagram illustrating a seventh presentation example using the presentation information created by the presentation information generation device 100 according to the present disclosure.

A presentation image 1600 is an image presented on the presentation device 200 by using the presentation information.

The presentation image 1600 includes a captured image 1610, an air flow image 1620, and a message image 1630.

The captured image 1610 is a monitoring camera image as sensor data.

The air flow image 1620 is an image which indicates an air flow and which is superimposed on the captured image 1610.

The message image 1630 is, for example, an image based on air flow information, such as “A large wind flow is generated from bottom to top at the center”.

Here, a hardware configuration for implementing functions of the presentation information generation device 100 (100A, 100B, 100C, 100D, or 100E) according to the present disclosure will be described.

FIG. 23 is a diagram illustrating a first example of the hardware configuration for implementing the functions of the presentation information generation device 100 (100A, 100B, 100C, 100D, or 100E) according to the present disclosure.

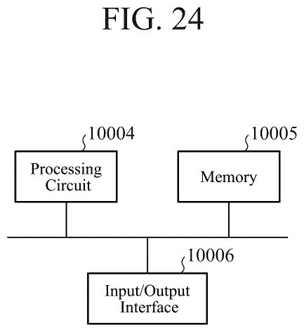

FIG. 24 is a diagram illustrating a second example of the hardware configuration for implementing the functions of the presentation information generation device 100 (100A, 100B, 100C, 100D, or 100E) according to the present disclosure.

The presentation information generation device 100 (100A, 100B, 100C, 100D, or 100E) of the present disclosure is implemented by hardware as illustrated in FIG. 23 or 24.

The presentation information generation device 100 (100A, 100B, 100C, 100D, or 100E) includes a processor 10001 and a memory 10002 as illustrated in FIG. 23.

The processor 10001 and the memory 10002 are mounted on a computer, for example.

The memory 10002 stores a program for causing the computer to function as the information acquisition unit 110 (110A, 110B, 110C, 110D, or 110E), the passenger detection unit 120 (120B, 120C, 120D, or 120E), the air flow calculating unit 130 (130A, 130B, 130C, 130D, or 130E), the presentation information generating unit 150 (150A, 150B, 150C, 150D, or 150E), the presentation information output unit 160, the ventilation command unit 170, and the control unit (not illustrated). By the processor 10001 reading and executing the program stored in the memory 10002, the functions of the information acquisition unit 110 (110A, 110B, 110C, 110D, or 110E), the passenger detection unit 120 (120B, 120C, 120D, or 120E), the air flow calculating unit 130 (130A, 130B, 130C, 130D, or 130E), the presentation information generating unit 150 (150A, 150B, 150C, 150D, or 150E), the presentation information output unit 160, the ventilation command unit 170, and the control unit (not illustrated) are implemented.

In addition, a storage unit (not illustrated) is implemented by the memory 10002 or another memory (not illustrated).

The processor 10001 uses, for example, a central processing unit (CPU), a graphics processing unit (GPU), a microprocessor, a microcontroller, or a digital signal processor (DSP).

The memory 10002 may be a nonvolatile or volatile semiconductor memory such as a random access memory (RAM), a read only memory (ROM), an erasable programmable ROM (EPROM), an electrically erasable programmable read only memory (EEPROM), or a flash memory, may be a magnetic disk such as a hard disk or a flexible disk, may be an optical disc such as a compact disc (CD) or a digital versatile disc (DVD), or may be a magneto-optical disk.

The processor 10001 and the memory 10002 are connected in a state where data can be transmitted between the processor 10001 and the memory 10002. In addition, the processor 10001 and the memory 10002 are connected in a state where data can be transmitted between the processor 10001 and the memory 10002, and other hardware via an input/output interface 10003.

Alternatively, the functions of the information acquisition unit 110 (110A, 110B, 110C, 110D, or 110E), the passenger detection unit 120 (120B, 120C, 120D, or 120E), the air flow calculating unit 130 (130A, 130B, 130C, 130D, or 130E), the presentation information generating unit 150 (150A, 150B, 150C, 150D, or 150E), the presentation information output unit 160, the ventilation command unit 170, and the control unit (not illustrated) may be implemented by a dedicated processing circuit 10004 as illustrated in FIG. 24.

The processing circuit 10004 uses, for example, a single circuit, a composite circuit, a programmed processor, a parallel programmed processor, an application specific integrated circuit (ASIC), a programmable logic device (PLD), a field-programmable gate array (FPGA), a system-on-a-chip (SoC), or a system large-scale integration (LSI).

In addition, a storage unit (not illustrated) is implemented by a memory 10005 or another memory (not illustrated).

The memory 10005 may be a nonvolatile or volatile semiconductor memory such as a random access memory (RAM), a read only memory (ROM), an erasable programmable ROM (EPROM), an electrically erasable programmable read only memory (EEPROM), or a flash memory, may be a magnetic disk such as a hard disk or a flexible disk, may be an optical disc such as a compact disc (CD) or a digital versatile disc (DVD), or may be a magneto-optical disk.

The processing circuit 10004 and the memory 10005 are connected in a state where data can be transmitted between the processing circuit 10004 and the memory 10005. In addition, the processing circuit 10004 and the memory 10005 are connected in a state where data can be transmitted between the processing circuit 10004 and the memory 10005, and other hardware via an input/output interface 10006.

Note that the functions of the information acquisition unit 110 (110A, 110B, 110C, 110D, or 110E), the passenger detection unit 120 (120B, 120C, 120D, or 120E), the air flow calculating unit 130 (130A, 130B, 130C, 130D, or 130E), the presentation information generating unit 150 (150A, 150B, 150C, 150D, or 150E), the presentation information output unit 160, the ventilation command unit 170, and the control unit (not illustrated) may be implemented by different processing circuits, or may be collectively implemented by a processing circuit.

Alternatively, some of the functions of the information acquisition unit 110 (110A, 110B, 110C, 110D, or 110E), the passenger detection unit 120 (120B, 120C, 120D, or 120E), the air flow calculating unit 130 (130A, 130B, 130C, 130D, or 130E), the presentation information generating unit 150 (150A, 150B, 150C, 150D, or 150E), the presentation information output unit 160, the ventilation command unit 170, and the control unit (not illustrated) may be implemented by the processor 10001 and the memory 10002, and the remaining functions may be implemented by the processing circuit 10004.

Note that, in the present disclosure, the embodiments can be freely combined with one another, any component in the embodiments can be modified, or any component in the embodiments can be omitted within the scope of the present invention.

### INDUSTRIAL APPLICABILITY

The presentation information generation device according to the present disclosure is suitable for use in, for example, an information presentation system that presents information in a passenger car of an elevator disposed in a building or the like.

### REFERENCE SIGNS LIST

1, 1A, 1B, 1C, 1D, 1E: information presentation system, 10 (11, 12, 13, 14, 15, 16, 17): ventilation equipment, 20, 20D, 20E: ventilation equipment control unit, 30: sensor unit, 31: weight sensor, 32: radar sensor, 33: camera, 34: temperature sensor, 35: humidity sensor, 36: infrared sensor, 40, 40D, 40E: passenger car operation control unit, 100, 100A, 100B, 100C, 100D, 100E: presentation information generation device, 110, 110A, 110B, 110C, 110D, 110E: information acquisition unit, 120, 120B, 120C, 120D, 120E: passenger detection unit, 130, 130A, 130B, 130C, 130D, 130E: air flow calculating unit, 150, 150A, 150B, 150C, 150D, 150E: presentation information generating unit, 160: presentation information output unit, 170: ventilation command unit, 200: presentation device, 210: display unit, 220: sound output unit, 300, 300A, 300B, 300C, 300D, 300E: air flow information database, 400, 400A, 400B, 400C, 400D, 400E: image database, 1000, 1100, 1200, 1300, 1400, 1500, 1600: presentation image, 1010, 1020, 1110, 1120, 1210, 1220, 1510, 1530: arrow image, 1030, 1130, 1230, 1310, 1410, 1520, 1540, 1550, 1630: message image, 1040: person image, 1610: captured image, 1620: air flow image, 10001: processor, 10002: memory, 10003: input/output interface, 10004: processing circuit, 10005: memory, 10006: input/output interface

1. A presentation information generation device comprising:
air flow calculating circuitry to acquire ventilation equipment information indicating a state of ventilation equipment in a passenger car, and to output air flow information regarding an air flow in a car interior of the passenger car by using the ventilation equipment information;
presentation information generating circuitry to generate and output an air flow image indicating a state of the air flow in the passenger car by using the air flow information output by the air flow calculating circuitry; and
presentation information output circuitry to cause a display to present the air flow image output from the presentation information generating circuitry, wherein
the ventilation equipment is disposed in such a way as to generate a plurality of air flows including at least an air flow between a ceiling central portion and a floor central portion in the car interior of the passenger car, and
the air flow calculating circuitry outputs the air flow information by further referring to an air flow information database that stores in advance a relationship between a state in the passenger car and an air flow.

2. The presentation information generation device according to claim 1, comprising passenger detection circuitry to detect a passenger in the passenger car, wherein
the air flow calculating circuitry outputs the air flow information regarding the air flow in the passenger car by further using passenger information indicating the passenger detected by the passenger detection circuitry.

3. The presentation information generation device according to claim 2, wherein
the presentation information generating circuitry generates the air flow image indicating the state of the air flow in the passenger car by further using the passenger information.

4. The presentation information generation device according to claim 3, wherein
the passenger information includes position information indicating a position where the passenger is in the passenger car, and
the presentation information generating circuitry generates the air flow image indicating the state of the air flow in the passenger car together with the position of the passenger in the passenger car.

5. The presentation information generation device according to claim 3, wherein
the passenger information includes physique information,
the air flow calculating circuitry outputs the air flow information regarding the air flow in the passenger car by further using the physique information, and
the presentation information generating circuitry generates the air flow image indicating the state of the air flow in the passenger car together with a physique of the passenger in the passenger car.

6. The presentation information generation device according to claim 1, wherein
the air flow calculating circuitry acquires operation information indicating an operating situation of the passenger car or an operating state of the passenger car, and outputs the air flow information regarding the air flow in the passenger car by further using the operation information.

7. The presentation information generation device according to claim 1, wherein
the air flow calculating circuitry acquires sensor data indicating an air environment in the car interior of the passenger car, and outputs the air flow information regarding the air flow in the passenger car by further using the sensor data.

8. The presentation information generation device according to claim 1, wherein
the presentation information generating circuitry generates and outputs the air flow image indicating the state of the air flow in the passenger car by further referring to an image database that stores in advance a relationship between the air flow information and an image indicating the state of the air flow.

9. The presentation information generation device according to claim 2, comprising ventilation command circuitry to command the ventilation equipment to perform ventilation on a basis of the passenger information or the air flow information.

10. The presentation information generation device according to claim 9, wherein
the ventilation command circuitry issues a command indicating a door opening time of the passenger car on a basis of the passenger information or the air flow information, and
the presentation information generating circuitry outputs the air flow image including the time indicated in the command issued by the ventilation command circuitry.

11. The presentation information generation device according to claim 1, wherein
the presentation information generating circuitry acquires a captured image obtained by imaging the car interior of the passenger car, superimposes the air flow image indicating the state of the air flow in the passenger car on the captured image, and outputs a resultant superimposed image.

12. A presentation information generation method comprising:
acquiring ventilation equipment information indicating a state of ventilation equipment in a passenger car, and outputting air flow information regarding an air flow in a car interior of the passenger car by using the ventilation equipment information;
generating and outputting an air flow image indicating a state of the air flow in the passenger car by using the air flow information; and
causing a display to present the air flow image, wherein
the ventilation equipment is disposed in such a way as to generate a plurality of air flows including at least an air flow between a ceiling central portion and a floor central portion in the car interior of the passenger car, and
the air flow information is outputted by further referring to an air flow information database that stores in advance a relationship between a state in the passenger car and an air flow.
